(19) United States
(12) Patent Application Publication
(10) Pub. No.: US 2005/0015610 A1
(43) Pub. Date: Jan. 20, 2005

(54) Method for anonymous computerized processing of documents or objects

(76) Inventor: Jean Pierre Moussette, Montpellier (FR)

Correspondence Address: YOUNG & THOMPSON, 745 SOUTH 23RD STREET, 2ND FLOOR, ARLINGTON, VA, 22202, US

(21) Appl. No.: 10/490,427

(22) PCT Filed: Sep. 24, 2002
(86) PCT No.: PCT/FR02/03261

(30) Foreign Application Priority Data
Sep. 24, 2001 (FR) 01/12294

(51) Int. Cl. H04L 9/00

(52) U.S. Cl. 713/200

(57) ABSTRACT

The invention concerns a method comprising: a) associating with or incorporating (1716) in the physical element a single information medium, including: i) an author section bearing a first predetermined code, ii) at least an administration section bearing a second predetermined code; b) permanently associating an identification of the author with the author section (1717); c) separating the author section from the physical element with each administration section (1740); d) processing the material element (1775) of the separated author section to supply at least a processing result; e) scanning the author section (1783) to read and associate the first code with the author identification; f) scanning at least an administration section (1784), to read and associate the second code with at least a processing result; and g) matching (1785), via codes, at least a processing result with the author identification.

The present invention relates to a process and a form for anonymous processing of a material element, a machine and a label to use them in particular modes. It is applicable particularly to the processing of examination sheets so that the score will not be influenced by knowledge of the identity of their author.

The problem of keeping anonymous documents or physical data pertaining to a person or an institution or any element having connection with an identification, relates to numerous activities: examinations, recruitment competitions, investigations of different types, particularly medical, tests of all types. These activities often involve conflicts of interest or the respecting of private life. To deal with our technical solution, we will give an example in the case of examinations of the educational type, but in all cases requiring them, during an intermediate phase, the anonymous processing of sensitive data, the principles and the techniques are identical.

The problem with which are confronted institutions, universities, public or private establishments, administering examinations or competition, is to ensure the candidates an anonymity guaranteeing them impartiality of their grading.

The problem is twofold:

1) It is necessary that the corrector can in no case recognize a candidate by reason of the identification of the copy provided by the managing organism (we don't have the aim of preventing recognition of the handwriting by the corrector, this is a different and marginal problem): in case of a corrector being able to disfavor a candidate.

2) It is not necessary that the candidate be able to transmit identification elements of his copy to the corrector: the case of a corrector being able to favor a candidate.

The present processes used are all based on manual modalities:
foldable adhesive patch, hiding the handwritten identity of the candidate,
double indexing a posteriori of the copies: a number on the portion identified by the candidate, the same number on the copy itself, with trimming of the identified portion,
assignment of an independent bar code, personal to each candidate, to be stuck on the copy . . .

These processes are particularly difficult to use and encounter problems of human management, both as to quantity and as to quality, as to the monitoring of the safety protocols of these processes, because they require a considerable time whilst being easy to evade.

Moreover, these processes are additive to the difficult procedures of supervision and normal surveillance of an examination, and thus require a great deal of responsible and well-qualified work that is hard to match to present standards, because they generate backups at certain times such that it is quite often impossible to follow the provided safety procedures. Generally speaking, many people have or could easily have access, with these procedures, for a substantial period of time, to information on the data and have the possibility of influencing the result.

These processes only vary imperfectly meet the problem of processing the copies anonymously without permitting:
guaranteeing respect for its good execution,
managing more generally the tests, or
handling by computer the or above all several independent results for a same data (double correction) for effective control.

The present invention seeks to overcome these drawbacks.

To this end, the present invention seeks, according to a first aspect, a process for anonymous and computerized processing of a document or physical element, hereafter called “physical element”, whose author or owner, hereafter called “author”, must remain unknown during processing of the physical element, this process being characterized in that it comprises:
a step of association or integration with the physical element of a unique information support, comprising:
   an identification section of the author called “author” section bearing a first predefined code,
   at least one so-called “administration” section each carrying a second predefined code identical to or different from the first predefined code,
   these sections forming a unique couple, the codes being defined prior to the association or integration step,
a step of permanent association of an identification of the author with the author section;
a step of separation of the author section and the physical element, each administration step remaining attached or integrated to the physical element;
a step of processing the physical element separated from the author section, to provide at least one processing result of the physical element;
a step of reading from the author section to read and associate the first identification code of the author of the physical element;
a step of reading at least one administration section, to read and associate the second code with at least one processing result of the physical element;
a step of matching by means of codes, at least one processing result with the identification of the author of the physical element, permitting ending the anonymity;
   at least one of the reading steps comprising an optoelectronic reading and recognition phase.

Thanks to these arrangements, all the author sections can be easily isolated during the step of processing, for example a correction phase of the tests, and the matching of the processing results and the author identifications is very rapid whilst being carried out by only a unique dedicated person.

According to particular characteristics, the first author code is unique and different from each second code, which is also unique.

Thanks to these arrangements, the risk of communication is decreased.

According to particular characteristics, the relationship between the first code and each second code is generated by an unpredictable computer algorithm which uses a random variable and in that the value of said variable and/or a table for matching the codes, are memorized.

According to particular characteristics, the relationship between the first code and each second code is generated by an unpredictable computer algorithm which uses a variable representative of a type of content of the physical element and in that the value of said variable and/or a table of correspondence of the codes, are memorized.

According to particular characteristics, at least one administrative section constitutes the physical element.

According to particular characteristics, in the course of the processing step, the information carried by the author on the administration section is processed and there is supplied at least one result in the form of at least one value or grade.

Thanks to each of these arrangements, a multiple choice questionnaire or any personal medical formulation can be processed in an anonymous manner, integrated with the administration section.

According to particular characteristics, the unique information support comprises an identification stub comprising one of the codes, said stub remaining connected to the physical element permanently.

Thanks to these arrangements, even if all the sections, author and administration, have been detached, there can be assured the traceability of the test thanks to the permanent association of the stub, which carries one of the codes and of the physical element.

According to particular characteristics, the process as briefly set forth above comprises a step of inscribing at least one result of the processing step on at least one administration section and a step of separating at least one administration section from the physical element, before the step of reading said administration section.

Thanks to these arrangements, the corrector or correctors can render the grades by providing administration sections which concern them, these grades being adapted to be read during the processing, reinforcing the interest of our process by providing a double solution to the problems of anonymity and of the reliable and automatic acquisition of the grades.

According to particular characteristics, the process as briefly set forth above comprises a step of masking at least one of the codes at least until the step of separating the author section.

Thanks to these arrangements, each masked code is protected against any disclosure rendering totally impossible the knowledge of the identity of the author before the procedure of canceling anonymity.

According to particular characteristics, the unique information support comprises several detachable administration sections bearing the same second unique code and a supplemental code defining the number of the section. Thanks to these arrangements, several correctors can correct successively the physical element and without knowing the results given by the other correctors, thereby rendering effective the principle of double correction.

According to particular characteristics:
at least one of the codes is integrated into a grid of alphanumeric values, comprising at least one alphanumeric symbol per case, the elements of the code having a predetermined place in the grid, and/or
at least one of the codes corresponds to graphical signs integrated into a grid of graphical signs whose elements corresponding to the code have a predetermined position in the grill.

Thanks to each of these arrangements, the code is very difficult to crack if the predetermined positions in the grid are not known, this place being able to depend on a special coding of a case.

According to a second aspect, the present invention provides a machine for re-indexing the identified elements in a manner that is handwritten or by codes, using the process such as briefly set forth above, which comprises:
a reading device by optoelectronic process, of a handwritten identification or a code, carried by the physical element or on the unique information support;
a computer device for registering the handwritten identification and/or code read in a digital file and which associates in said digital file an explicit and sequential index code adapted to be visually read and interpreted;
a device for printing this index code;
a system of masking the handwritten identification and/or the code read on each physical element,
   such that each physical element is thus re-indexed in an anonymous manner and adapted to be visually interpreted.

Thanks to these arrangements, even if a second code is known, the correspondence with the index code remains unknown and any trickery is impossible.

According to a third aspect, the present invention provides a form for anonymous processing of a physical element, which comprises:
an author section associated with a first code and adapted to receive an identification of the author of the physical element;
at least one second administration section associated with a second code identical to or different from the first code;
   these sections being connected to form a unique couple, the codes being either identical and specific for each form, or different and corresponding for each form in an unpredictable manner, the form being adapted to be secured to the physical element, the author section being provided to be detached from the administration section, the administration section remaining associated with the physical element. So as to be able to detach the administration section to permit particular processing, a stub system comprising a first or second code or a code representative of these latter, is provided.

The particular characteristics and advantages of this form being identical to those of the process briefly set forth above, they will not be repeated here.

The present invention provides, according to a fourth aspect, a label for masking code used in the process as briefly set forth above, or form forms such as briefly set forth above, this label being opaque and comprising a pre-cutout of an internal zone which is detached and exposes at least one code previously printed on at least one of the sections.

Thanks to these arrangements, at least one of the codes used, according to the present invention, can be masked during a portion of the processing of the physical elements.

Other advantages, objects and characteristics of the invention will become apparent from the following description, given with respect to the accompanying drawings, in which:

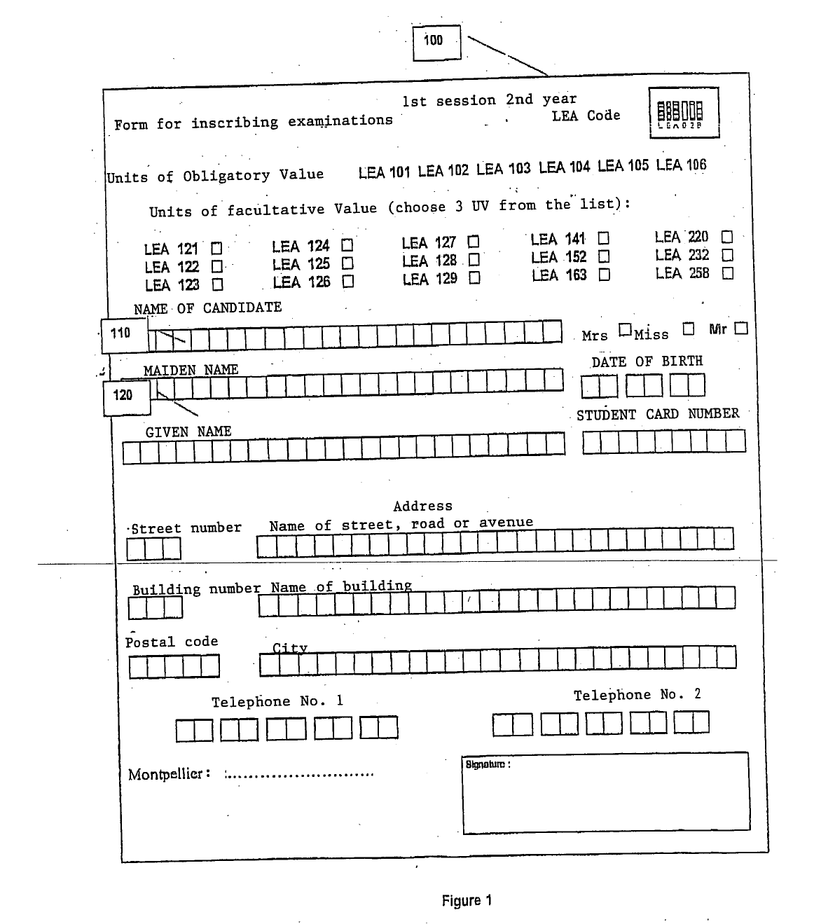

FIG. 1 is a form for inscribing a test,

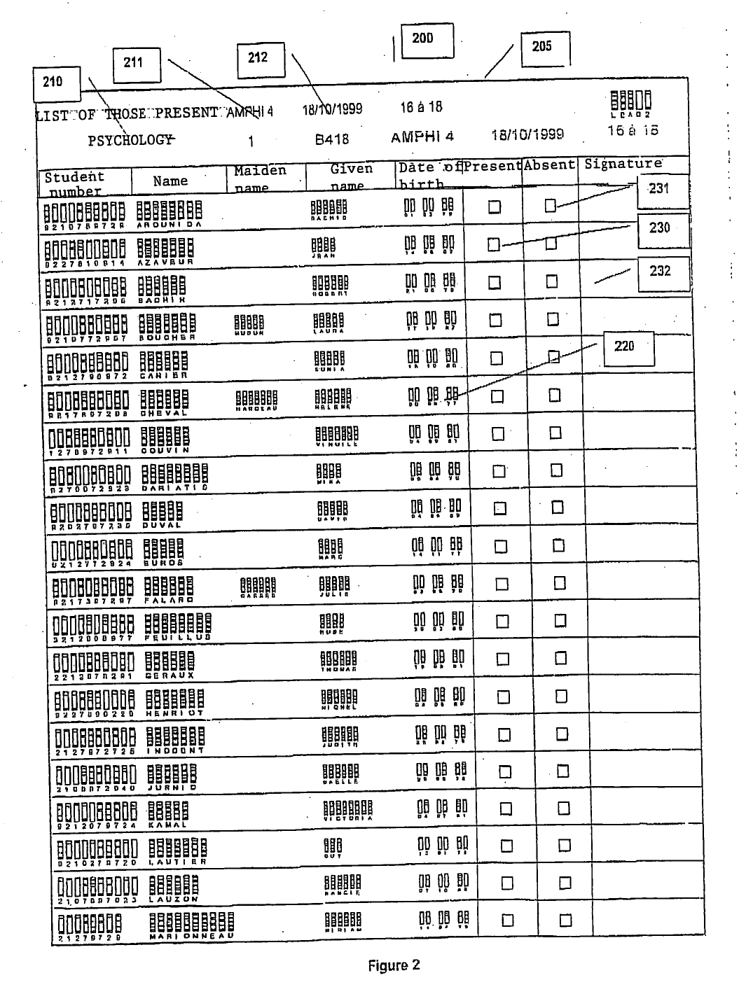

FIG. 2 represents a list of presence used in an embodiment of the process according to the present invention,

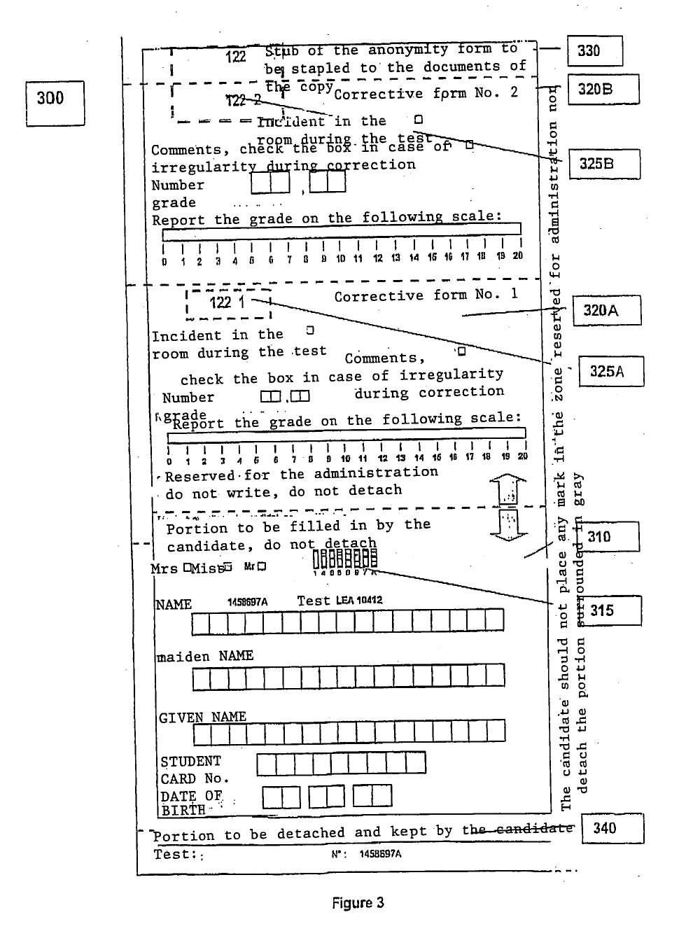

FIG. 3 represents a form according to a particular embodiment of the present invention,

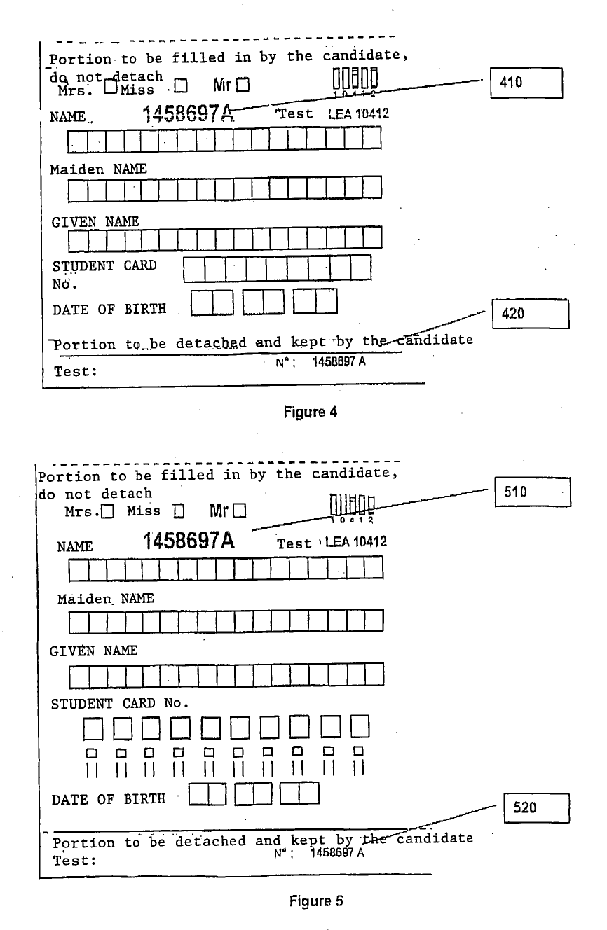

FIG. 4 represents an example of an author section of a form according to a particular embodiment of the present invention,

FIG. 5 represents an example of an author section of a form according to another particular embodiment of the present invention,

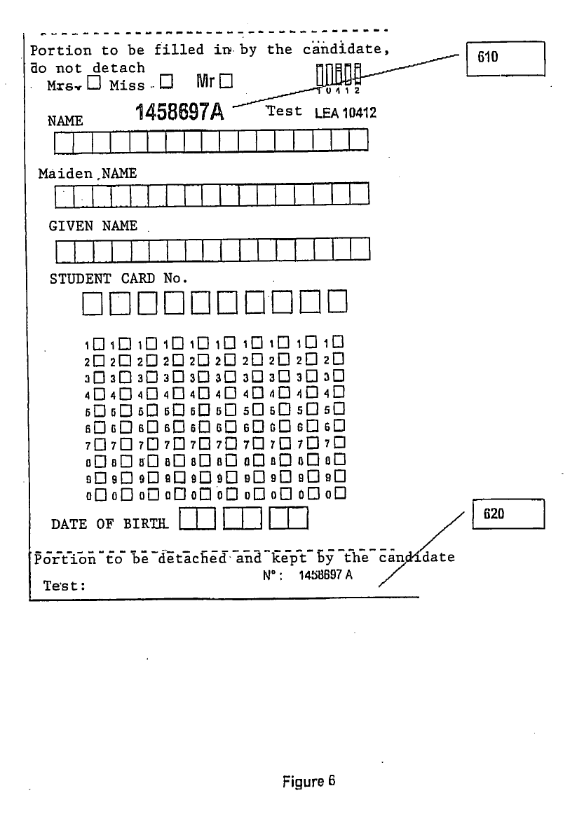

FIG. 6 shows an example of an author section of a form according to another particular embodiment of the present invention,

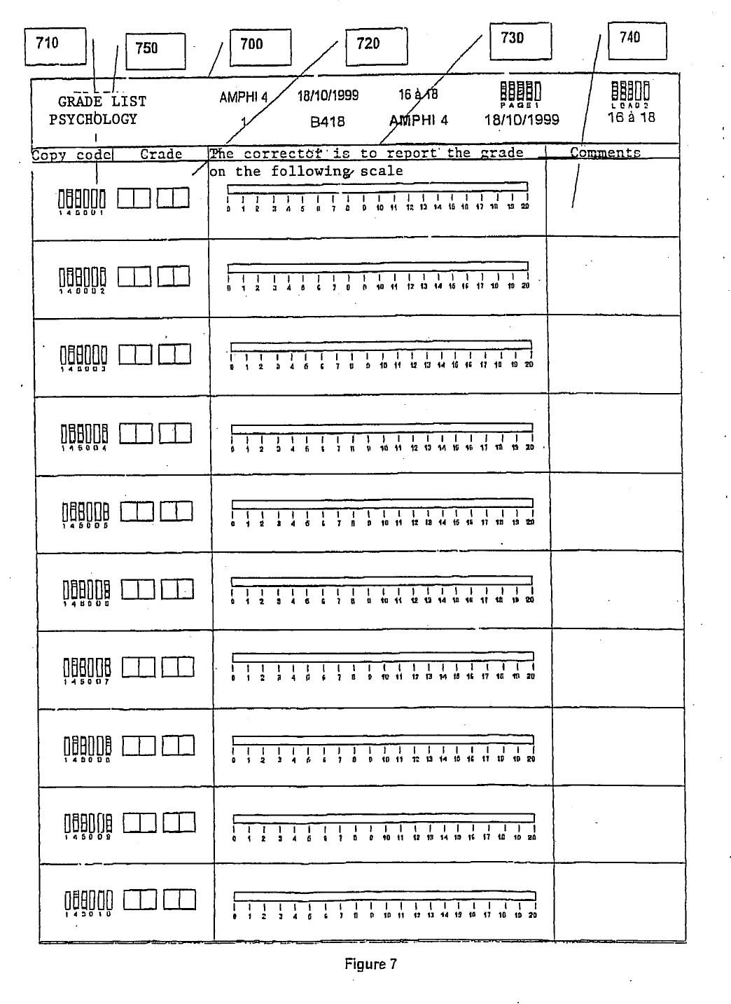

FIG. 7 shows an example of a list of notation according to a particular embodiment of the present invention,

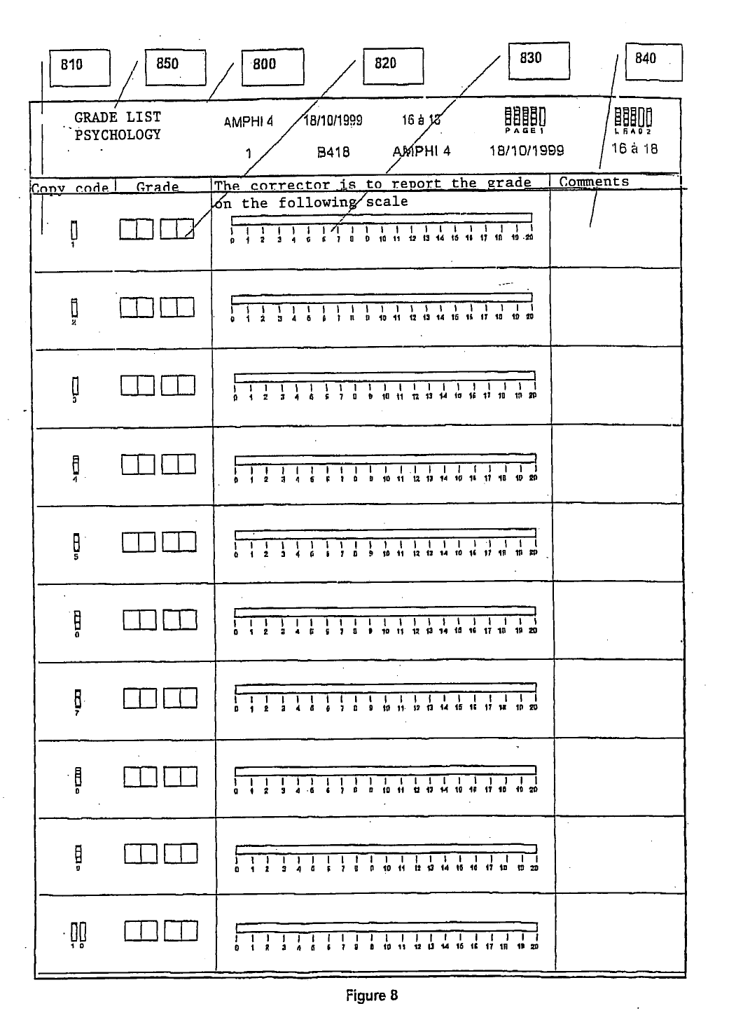

FIG. 8 shows an example of a list of notation according to another particular embodiment of the present invention,

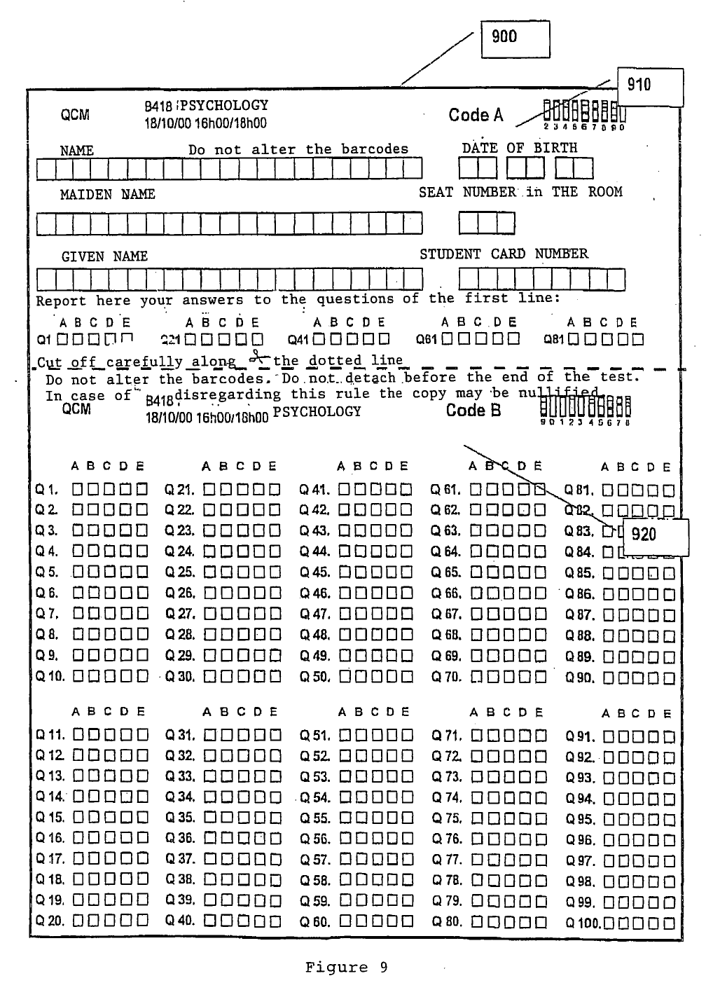

FIG. 9 shows an example of an administrative section including a QCM form according to an embodiment of the present invention,

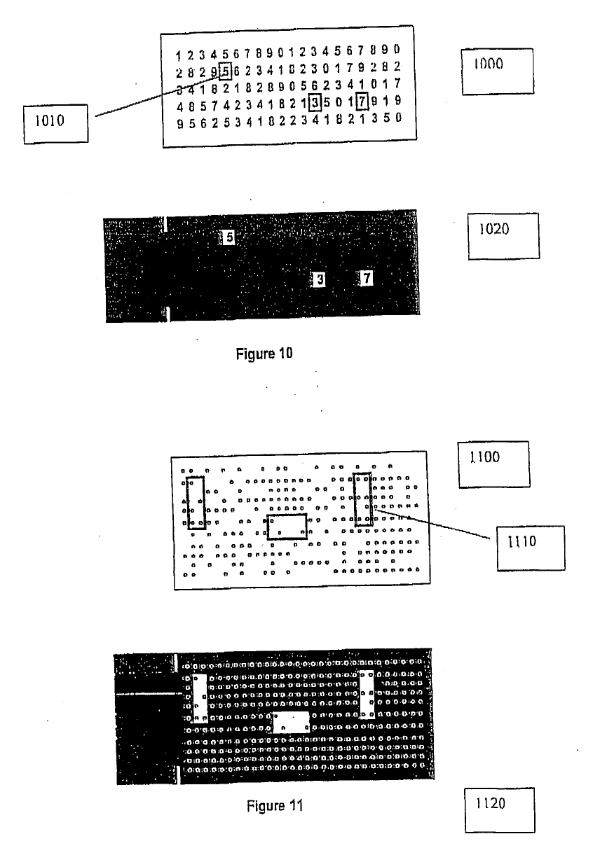

FIGS. 10 and 11 show coding systems used in the particular embodiments of the present invention,

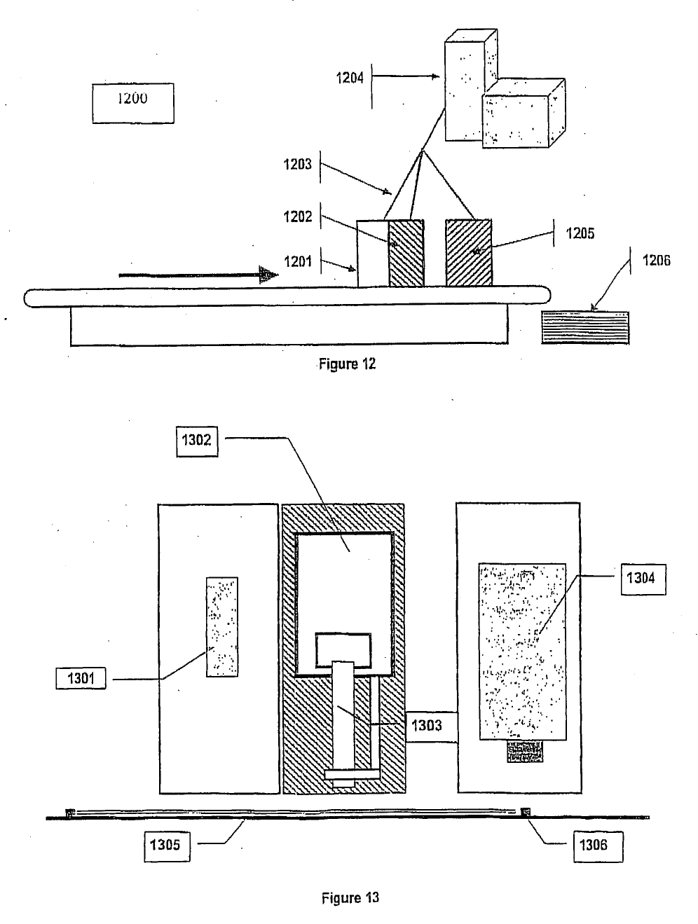

FIG. 12 shows a machine to be indexed according to an embodiment of the present invention,

FIG. 13 shows a detailed view of the machine shown in FIG. 12,

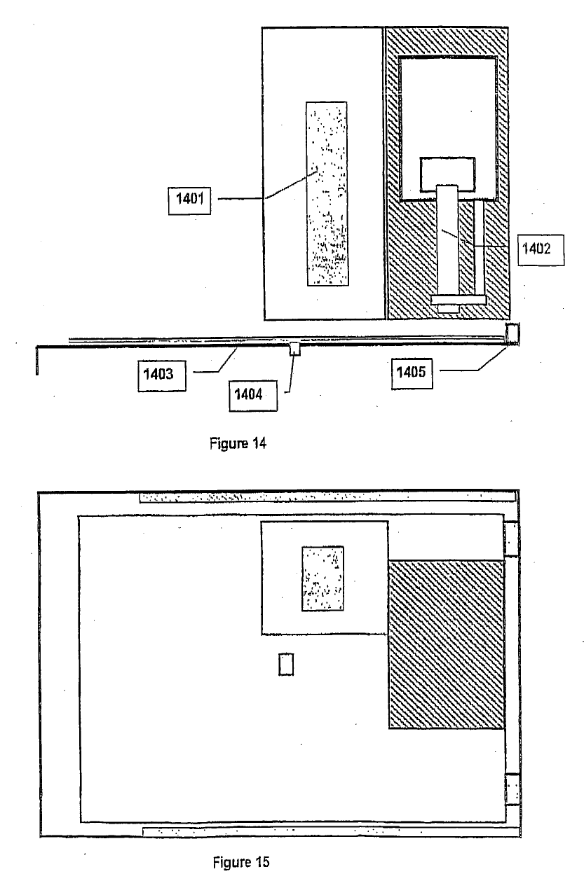

FIG. 14 shows another detailed view of the machine shown in FIGS. 12 and 13,

FIG. 15 shows another detailed view of the machine shown in FIGS. 12 to 14,

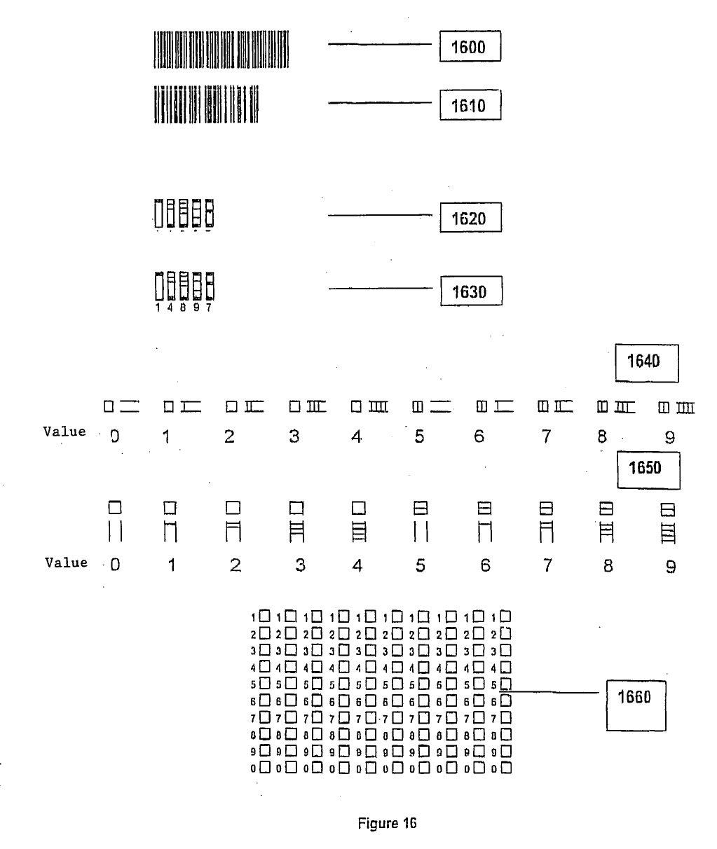

FIG. 16 shows graphical codes used in particular embodiments of the present invention,

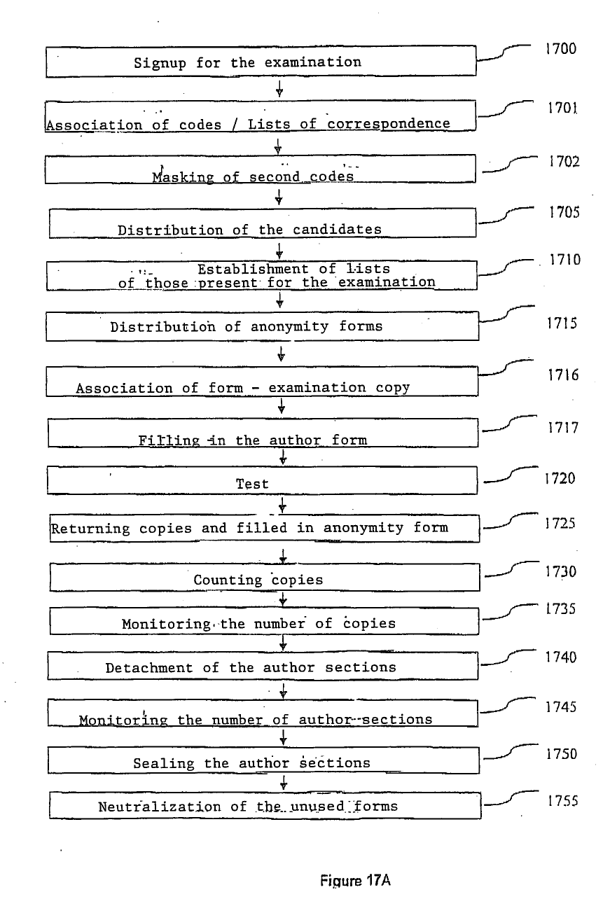

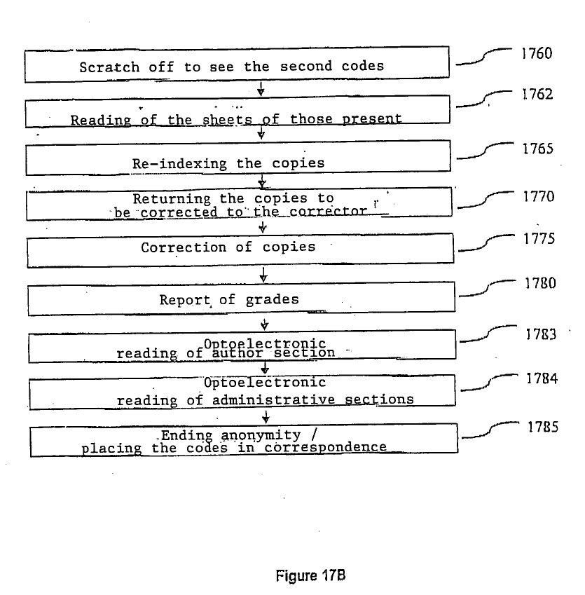

FIGS. 17A and 17B show an organigram of a process according to a particular embodiment of the present invention,

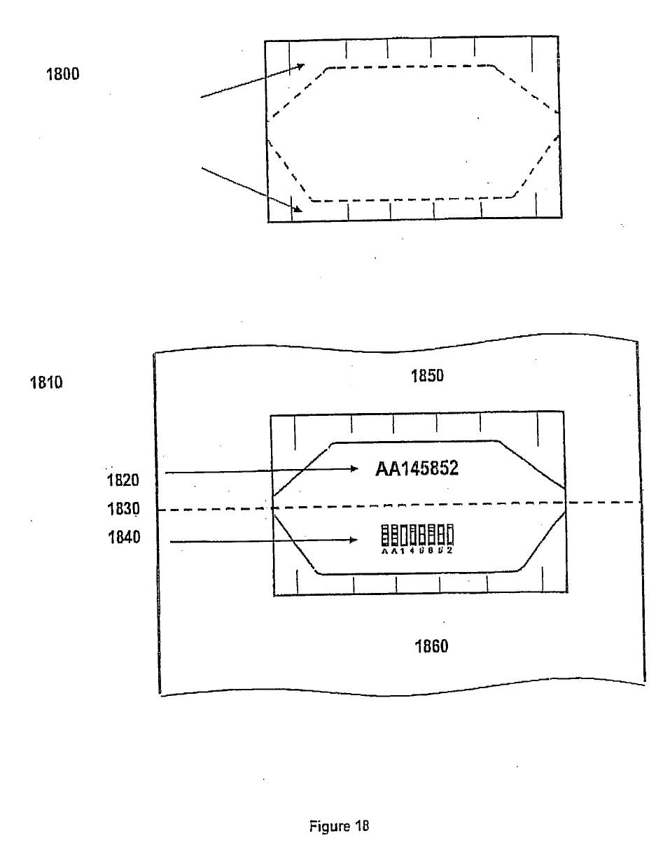

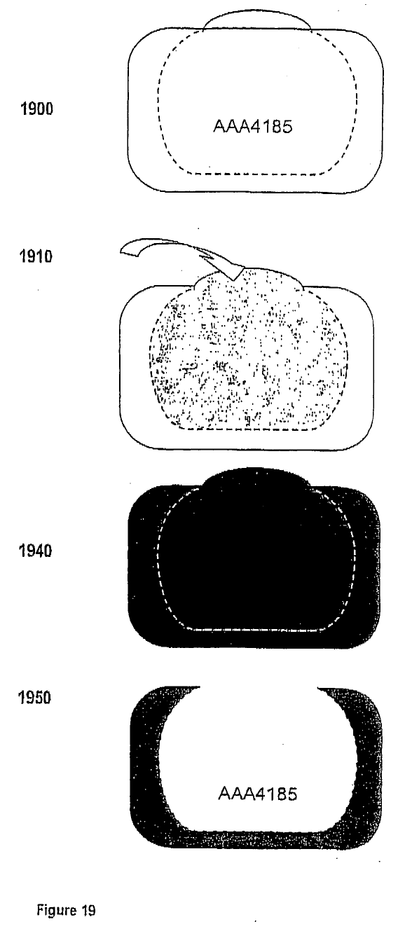

FIGS. 18 and 19 show types of labels according to a particular embodiment of the present invention.

Before describing these figures, there will be given below general explanations.

The process according to the present invention assembles, in a preferred embodiment, an assembly of modalities based on computer processing by scanner reading of handwritten data which, overall, considerably reduce the time necessary for the management of an examination whilst providing security of anonymity which is impossible to evade. Thus, a unique person suffices to have access to the key to the anonymity, this key being adapted to be different for each test, its use being instantaneous and adapted to be guaranteed by a safety deposit. The process according to the invention moreover has, according to certain modifications, the possibility of manual processing for safety which avoids any question as to the reliability whilst permitting totally anonymous practice by all persons even those unqualified in computer.

The process according to the present invention combines, in a preferred embodiment, the computerized reading by scanner:
handwriting and alphanumeric printing,
cases to be checked off, scales, standard 1610 barcodes or specific 1620, 1630 barcodes,
of alphanumeric or graphical codes for optical reading that can be read without apparatus, and/or
of 1640, 1650, 1650 codes set forth in French application No. 95 10 803, the disclosure of which is incorporated herein by reference.

There will be given below a description of the process applied to the management of an examination in all its particular phases.

1) Writing of Examinations, Step 1700 in FIG. 17A

Each candidate is identified by his name, given name, birthday, address, identification number, in all or in part, these elements being adapted to be acquired by computer, directly or from an existing base (for example inscription at the university).

In particular embodiments, the present invention uses an individual form shown in FIG. 1 guaranteeing the juridic act of inscription. This individual Form 100 comprising boxes for handwritten insertions 110, wording 120 and, once instructed, handwritten annotations (not shown), is read by scanner and defines each group of instructions per test. The inscription with juridically reliable form can be associated with an inscription of the Internet or Intranet line giving to the candidate, thereafter, access to any information on the examination: time, room, modality, confirmation of validity of his inscription and possible problems.

From inscriptions thus defined per test, the examination service divides the candidates by examination center and by room, and establishes lists of presence 200, shown in FIG. 2, per center and per room, and this automatically, as a function of predetermined criteria: availability of rooms, capacity of each room relative to the examination conditions. Then the particular embodiment shown in FIG. 2, the list of presence 200 comprises a box 205 in which are inscribed the references of the exam, 210 of the examination room, 211 the date, 212, and for each candidate, indications of numerical identification, names, given names and birth date 220 in the form of printed characters and/or barcodes, a box 230 to check off to indicate the presence of the candidate, a box to check off 231 to indicate the absence of the candidate and a signature box 232.

The list of presence 230 serves to call the roll of those present and as the case may be, the signature list. This list is provided to be read automatically so as to establish the effective presence of the inscriptions, step 1710. So as to facilitate their reading, the data (name, given name, . . . ) can be present in the form of explicit standard barcodes (not shown) of type 1600, 1610 or explicit codes of type 1630, as shown in FIG. 16.

2) The Anonymity Form So as to avoid any individual preparation of the copies or of labels generating numerous difficulties and the requirement for measuring safety and security that is always haphazard, the unique information support or “form” 300 shown in FIG. 3, according to the present invention, is joint or integral with the copies, this form is independent of the candidates and can thus be distributed to no matter which candidate, step 1715.

The process according to the present invention has two variants:
a—the use of a form 300 independent from the copy and then associated (for example stapled or glued), step 1716, by its stub 330 to the copy of a candidate with one or desired several detachable sections called “administration” 320a, 320b, and a detachable section called “author” 310, comprising as the case may be a portion to be kept by the candidate 340.
b—the integration of the copy into the unique information support or “form” 900 shown in FIG. 9, with one or if desired two detachable sections called “administration” 920, a detachable section called “author” 910, as the case may be a portion to be kept by the candidate (not shown), and a zone adapted to be filled in by the candidate in the course of the test (questionnaire, multiple choice questionnaire, free writing, for example). This zone is in the embodiment shown in FIG. 9, included in the administration section 920.

The forms 300 comprise:
the author section 310, comprising a so-called “first” code 315 or “code A”,
one or several administration sections 320A, 320B (for the case of double or multiple corrections), comprising a code 325A, 325B, called “second” code or “code B” belonging to each administration section, integrated with the copy, or connected to a stub 330,
if desired, the portion 340 to be kept by the candidate, bearing the first code.

In the embodiment shown in FIG. 3, the first code is a code in standard alphanumeric format, simple and readable. This identification of the author section is unique, and will not be given twice in the framework of the same examination.

Each section of the Form 300 bears a code readable by scanner. Two modifications of the process are proposed. They each rely on the use of two codes, A and B, of which the connection is impossible to establish (or unpredictable).

According to a first modification, the second code or codes are masked: this modification relies on:
a first simple alphanumeric code A, printed on the author section,
a second simple alphanumeric code B, different from the first code, printed on each administration section. This second code is masked by serigraphy that can be scratched off with a layer of security lacquer that can be colored or by any other masking process of the type of labels 1800, 1900, FIGS. 18 and 19, detachable once (not re-attachable, or not re-positionable), such that any attempt to scratch off or unmask leads inevitably to visual detection of the candidate's attempted fraud.

According to the second modification, the second code is not masked: This modification relies on:
A first simple alphanumeric code A, printed on the author section, repeated as the case may be on the portion 340 to be kept by the candidate,
A second unmasked code B but in the form of encrypted codes or barcodes that are not explained, of the type 39, 128 or other standards, or barcodes of the type of those of FIG. 16, 1620, to be read by a scanner, imprinted on each section reserved for administration and/or the corrector or correctors.

The general principle of the relationship between the first code and the second code is that, in the embodiment shown in FIG. 3, the first code is for simple alphanumeric reading. This permits the easy management of the fresh documents before the test: storage, attribution per test, per room and management of the test in the room. The numerals of this first code are followed, facilitating the use of the forms and their numbering. This code must not comprise possible duplicates within a same administration managing examinations, during a same session or for a same test.

This first code appearing only on the author section, its recognition does not in any case permit knowing its relationship to a candidate because the latter is at random in the room.

During printing the first code, the second code is simultaneously printed.

The second code is different from the first code and is associated with the first code A according to a rule known only to the designer of the software of the numbering system. This association is the product of random selection that can be combined with an algorithm processing in the series of numbers of the printed copies (a modification less complicated can read by a unique algorithm treatment the codes A and B).

Thus, let it be supposed that we print 2000 copies beginning with No. 1250081 and finish with No. 1252080, the correspondence by chance could give:

| CODE A | | CODE B |
|---|---|---|
| 1 250 081 | draws by lot | 1 252 004 |
| 1 250 082 | draws by lot | 1 251 608 |
| 1 250 083 | draws by lot | 1 250 152 |
| 1 250 084 | draws by lot | 1 251 493 |
| 1 250 085 | draws by lot | 1 250 741 |
| . . . | | |

The alphanumeric symbols, here digits of the second code, are masked upon printing or indecipherable by direct reading. When the author sections, bearing the first code, are detached from the Forms 300, the administration and corrector sections become impossible to re-associate with code A without having the corresponding computer file.

The copy being standard, any error or exceptional malfunction can be immediately corrected by the distribution of another Form 300 or of another copy.

It will be understood that the characteristics of the present invention guarantee inviolability of the correspondence of the codes by absence of a connection between the first code and the second code. In numerous cases, it is possible to be satisfied with a system of correspondence by coded algorithm that is more or less elaborate, kept secret, and accessible only to the unique person responsible for anonymity. A simple software protected by password serves in this case to “translate” between the first code and the second code. It is desirable that the correspondence algorithm be reserved for limited series of data to be rendered anonymous and be different from series to series. This possibility of correspondence by an algorithm between the first code A and the second code B defines a less complicated modification of our process.

In particular embodiments, the first and second codes are identical. In this case, if no code is hidden, the corrector cannot know the code of the author because the author section comprising the handwritten identification of the author is detached, the only possibility for fraud being the communication by the author of his code to the corrector; if the second administration code is hidden, the corrector cannot know the code of the author even if the author gives him his code, but an intervening administrator could establish the author-result relationship before ending anonymity.

These various modalities thus constitute a particular embodiment of the process according to the present invention.

The examination takes place as follows:

Beginning of Examination, Step 1710

The monitors control, at the beginning of the test, the presence from a list of presence 200 by identifying in each case those present. This list can serve as a signature list thanks to a region 340 on the candidate paragraph.

The monitors distribute the copies integrated into the forms according to the present invention or neutral copies and Forms 300, at the beginning of the test, step 1715. The distribution might obviously take place in a different order from the order of the places and, if possible, randomly by variable lots. The candidates fill out the author section of which examples are shown in FIGS. 4 to 6 without filling in any other portions.

The examination takes place, step 1720. If a candidate has a defective or torn Form 300 or if he commits an error in filling it in, his Form 300 is exchanged for another one.

End of Examination in the Room

At the end of examination, the candidates turn in their copies and the Forms 300 which are stapled or glued to the assembly of copies turned in by each copy, step 1725.

The monitors count the copies, step 1730, and after being satisfied of the correspondence between the number present and the number of copies, step 1735, they proceed in two stages:
in the course of step 1740, the monitors detach the author sections (FIGS. 4, 5, 6) by tearing off or cutting, thanks to a system of micro-perforations, then, after counting the number of author sections, the latter are sealed in a special “author section” envelope, step 1750, with identification of the lot: test, date, hour, number of forms from number X to number Y. The forms 300 or the copies containing the author section that are not distributed or exchanged, are separated and returned to the administration and are voided, step 1755.
if the second code is masked, the administration proceeds then to scratching off the serigraphy, by means of a scratch with a razor blade, or peeling off the maskings, step 1715, FIG. 17B, operations which take less than two seconds per copy.

FIG. 18 shows the case of masking labels 1800 adapted to mask two codes 1820 and 1840 and to permit automatic unmasking during separation of two sections or a section from a stub 1850 and 1860 along a tear-off line 1840.

FIG. 19 shows the case of a masking label 1900, 1940 adapted for masking one or several codes located in a same section, a non-adhesive portion can be easily torn off, 1910, by unmasking the code or codes 1950.

The copies are distributed by the administration to the corrector or correctors, step 1770 (the operation of unmasking can be carried out by the correctors or by the administration after notation).

So as to facilitate the procedures for manual operation in the case of an error of handling, it is recommended to manually index in certain cases the administration sections—corrector, by a numeral of order, from copy No. 1 to the last copy (the author section having been detached and the copies mixed so that the manual index will have no relationship to the first code A).

This method juxtaposes the encrypted code and an index to facilitate management, this juxtaposition being carried out automatically by the indexing machine shown in FIGS. 12 to 15, step 1765.

Each copy of the test is thus identified by a second code, with a random number relative to the distribution of the first codes or candidate numerals, numerals comprised between two limits: for example between No. 1250081 and No. 1252080. This series and its correspondence with the candidate numbers are available in a secured file in the position of the person responsible for the examinations. This series cannot be continuous to the origin, but it will necessarily be discontinuous at the arrival, because the quantity of sheets to be provided is greater than the number of inscriptions (for various incidents) and a fortiori of those present.

Correction takes place according to the usual methods, the corrector having to conform to the rule for possible annotations, step 1775. The problem which arises is that of the relationship of the result of the processing by the analysis or analyses or correctors. In the case of an examination, the result is present in the form of a grade or points. Several analysts or correctors can work on all the copies or on a partial physical aspect: second portion for example, or qualitatively: editorial quality.

The process according to the present invention permits several modes of reporting the results appropriate to the correction modalities which it permits in an original manner, step 1780. The reporting mode is according to the nature of the second code.

The report of the result with the detachable form by a first corrector, shown in FIG. 3, permits as desired the use of a second code B that is masked or unmasked. The grade attributed by the first corrector is reported on a first corrector section by the first corrector, this first corrector section is detached by the first corrector, then, after counting the number of first corrector sections, the latter are sealed in a special “first corrector” envelope, with identification of the lot: test, date, hour, name of the corrector, number of forms from No. X to No. Y.

The second grade is reported on a second corrective section by the second corrector, this second corrective section is detached by the second corrector then, after counting the number of second corrective sections, the latter are sealed in a special “second corrector” envelope, with identification of the lot: test, date, time, name of corrector, number of forms from No. X to No. Y.

A list and a report can be provided subsidiarily, permitting each corrector to confirm his grade and to establish a brief account per copy.

In the case of a report of the result on a list and correction report, this list can constitute a variant to the corrective sections. In this case, the administrative section of the anonymity Form 300 does not contain a corrective section but only an administrative stub. The list of corrections is established in the following manner:
1) in the case of use of a second masked code B, the administration know a priori the codes which are distributed in a test and unmasked after the test, without knowing their attribution to the authors because the latter are seated randomly at the beginning of the test. It thus suffices to set up by computer and preliminarily to the test a list with these second codes in order. The corrector having copies with the stub carrying the second code B unmasked, reports the grade on this stub and for copies of which he has the second code, on the list of notation for report of grades 700 shown in FIG. 7. The lines of the second codes of the copies or anonymity forms that are not distributed or exchanged remain empty. The corrector makes sure that there are as many grades as copies because he must do this within the conventional correction procedure. List 700 provided to be read by scanner necessarily comprises second codes B provided with the distribution. The number of anonymous forms distributed and hence of second codes B, is necessarily greater than the number of corrected copies because there are supplemental forms provided for accidents or for absent persons. For each copy, the list 700 comprises a copy code 710, zones of handwritten inscription of grades 720, a bar graph 730 to be completed to represent the corresponding grade, a region for comment 740 and a title region 750 in which is indicated the test in question.
2) in the case of the use of a second unmasked code B, the second code B is legible without a recognition system. The administrative stubs of the copies of each test are manually numbered from 1 to X (number of persons present). A section comprising the second code B and this order number is detached then read by a scanner, to produce an intermediate file placing in correspondence the second codes and indices. This enumeration can be carried out automatically by a machine shown in FIGS. 12 to 15, printing or labeling from 1 to X (number of persons present) each copy after reading the second code B by producing a reconciliation file. If the second code B is a barcode, a unique computer reading of the stubs of the lot can also generate automatically a computer file with printing of the list after deposit of the copies at the end of the examination. In this case, the list comprises only copies distributed to each corrector. The correspondence file between the second codes and the indices is carried out for the test and, as the case may be, per corrector or group of correctors. The corrector reports on the notation list to report grades 800 shown in FIG. 8, in the order of printed enumeration, the grade obtained. This modification is appropriate in the case of multiple corrections. A process of reconciliation is thus necessary (see the above). The notation list 800 comprises a title zone 850, which indicates the test in question, and for each copy, an index 810, of the zones 820, for handwritten inscription of the grade given the copy, a bar graph 830 on which the corrector can indicate graphically the given grade and a zone 840 for comments.

In the case of a report of the result with manual computer direct retrieval of the grade written on the stub, the corrector reports the result on the administrative stub. There are then acquired, by keyboard, the grades carried on the stubs, the acquisition of the grades taking place by attributing them to a number and not by the name of the candidate (which avoids any error in acquiring or any “intervention” between acquisition and the end of anonymity, which operation takes several days in a university).

The process according to the invention requires only one person and several seconds to end the anonymity and to pass in a secured manner the resulting file, step 785. According to the type of second code B, masked or not, the operation is different:
in the case of a report of the result with direct acquisition of the grade carried on the stub with the second masked code B, the acquisition is simple. The computer list of the unmasked codes is displayed by software of the spreadsheet or database type, the acquisition of the grades takes place on this base;
in the case of a report of the result with direct acquisition of the grade carried on the stub with a second unmasked code, if the result is unique or multiple without negatively judged interference between the correctors, the acquisition is carried out by one or two operators.
if the second code B is a barcode printed on the stub, the second code is decrypted by a handheld reader of barcodes, the reading of the second code in the form of barcodes can trigger the search for the second code in the list, and the acquisition of each grade is simple and is carried out by a unique person,
if the second code B is an alphanumeric grid code or a graphical grid code (see above), the reading is carried out by means of a reading mask and the acquisition of each grade is manually or automatically performed as a function of recognition of the position of each element of the second code in the grid.

The operations of “creating” anonymity and ending the anonymity involve an assembly of operations of successive disassociation and association.
1. Association, during production of the anonymity Form 300, step 1701, of the first code A and of the second code B, with creation of a secured correspondence file between these codes. This correspondence file is divided by commodity and by safety into lots of a definite number, for example into lots of 50 forms, the 50 numbers of the first organized code A corresponding to 50 numbers of the second code B. The division into lots is carried out from an assembly of anonymous Forms 300, for example ten thousand, corresponding to a unique system of concordance of the first and second codes. An algorithm for numbering from a random database connects the codes by using suitable numbering within the limits of 128 bits legally permitted.
2. Definition of a test and of the quality of anonymous Forms 300 that is necessary. Each test will have attributed a number of lots of Forms 300 permitting distributing at least one Form 300 per participant, these logs belonging to the same assembly.
3. After distribution of the anonymous Forms 300, the author section carrying the first code A is instructed by the candidate, step 1717: handwritten identification, name, given name, birth date, . . . or identification by a code belonging to the candidate, in the form of codes according to the invention set forth in patent application FR 95 10 803 and shown in FIGS. 6 and 16, or provided with boxes to be checked off shown in FIGS. 6 and 16. The administrative section carrying the second code B is left blank by the candidate.
4. At the end of the test, if the Form 300 is not integrated to the copy, it is associated with it, for example by gluing or stapling. After counting the copies and verification of the correspondence with the number of those present, the administration proceeds to detaching from the author stub carrying the first code A, on the one hand, the physical element, here the copy, associated or integrated with each administrative section carrying the second code B, and, if desired, the stub carrying the second code B, the second code B being masked or encrypted.

This phase of detachment of the portions, step 1740, requires the absolute adherence to standards of security for anonymity: integrity of the mask, absence of unexpected reading with uncrypting means of the second code B.
1. The unmasking of the second code B or its decryption, is not necessarily carried out after detachment of the author stub and before correction of the copy. A second explicit code B facilitates the management of the data but the latter can be perfectly well carried out with a masked or non-decrypted code.
2. The distribution of the copies to the correctors, corrections, analysis and association of one or several results (in the form of a value or grade) to a physical element, here a copy, step 1775. The process according to the present invention covers an assembly of possibilities of reports of results: unique, multiple, independent, overall or partial, step 1780.

The association of results with a copy can take place in different ways. The simplest consists in carrying on the anonymity Form 300, or on a section detachable from this Form 300, the result according to an established procedure, in a form legible by scanner, in its principle in a handwritten form, of codes described in patent application FR 95 10 803, FIG. 16, 1640, 1650, 1660, of scales or groups of boxes to be checked off. The second way consists in associating with the different copies one or several predefined lists of results whose number of results corresponds to the number of anonymous Forms 300 contained in the lots of copies attributed to the test. The first code A carried by these lists can take different forms. As the case may be, it is constituted:
1. by the second code B, if it is unmasked,
2. by a supplemental index carried, either manually or on anonymity Forms 300 (second code B remaining masked or second code B encrypted), either automatically (second code B encrypted) with the construction of a file establishing the correspondence between the second codes B and the indices (see the above system of automatic indexing).

The lists, made up before the test, comprise a number of possibilities of results equal to the number of anonymity Forms 300 provided for the test, indexed from 1 to X (number of forms provided).
1. Sorting out the results and placing these results in the form of a digital computer file. According to the reporting process selected, the results will be the object either of direct computer acquisition or a reading of the different sections of the anonymity Forms 300, or a reading of the lists of results. As the case may be, each copy will be the object of one or several results of different nature, which could be the object of the desired computer processing: addition, comparison, processing warnings, averages, statistics of all types.

At this point all the data remain completely anonymous.
2. Ending anonymity. This could take place for everyone involved or only for a portion of the latter, for all the results, for a portion of the results or for a unique result, these results being adapted to be the object of intermediate processing.

If the association of the results with the second codes B was the object of complementary indexing, one proceeds by means of the correspondence file between the second codes B and the indices, to the association of these latter to the second codes B.

Finally, under the monitoring of the person responsible who has access to the secured file of correspondence between the first codes A and the second codes B of the lots in question for the test, is carried out the partial or total matching between the identities of the participants and their results or grades, step 1785.

This system can be adapted to any form of monitoring permitting generalizing the automation of the management of the pedagogical data whilst using acquisition means by scanner: monitoring by multiple choice questionnaire (M.C.Q.), oral monitoring:
Monitoring by M.C.Q. uses an M.C.Q. form, such as shown in FIG. 9. In this case, the Form 900 is comprised by an author section 910, and an administrative section 920, filled in directly by the candidate. The code B or second code can be encrypted or masked by a simple label of the type shown in FIG. 19
In the case of oral monitoring, the grading forms are established. In this case, obviously, there is no anonymity, but there is automatic acquisition of the instructing grading forms.

For a complete management of anonymity according to our process, it is thus necessary to carry out the following operations, certain ones of which are optional:

1) Production of inscription forms shown in FIG. 1, reading the forms with software having motors for reading by scanner of handwritten material (Optical Character Reading, or OCR), of printed characters, standard barcodes or codes described in patent application FR 95 10 803, of encrypted codes showing FIGS. 10 and 11, of check boxes and graphical scales (this phase is optional).

2) Production of lists of those present shown in FIG. 2, by reference to the list of inscriptions per test, with if desired distribution per room (this phase is optional).

3) Production of anonymity forms 300, with the creation of a secured computer file for correspondence between the first codes A and the second codes B.

4) Production of lists of grading shown in FIGS. 7 and 8, if the anonymity form does not comprise the corrective section, or production of a form for reporting corrections, each of these forms being destined for a predetermined corrector before the examination (this phase is optional).

All the operations can be carried out well in advance of the test, without “bottleneck”, because the emplacement of these elements can be predetermined and carried out before the examination. Only the printing is preferably carried out in the weeks preceding the examination with extremely simple modern processes. The production of the copies themselves can be carried out independently of the anonymity forms, they can be made industrially and stored.

Operation of Management of Reading:

At the end of the first test, the signed forms of those present shown in FIG. 2 are given to a computer service which reads them automatically and establishes a first file per test. The author sections shown in FIGS. 4, 5 and 6 are read immediately so as to monitor the signing and to determine the values of the first codes A of the candidates present, so as to permit ultimately the end of anonymity of the results.

This system permits in advance the arrangement of the result of pre-managing the end of anonymity. Thus before the beginning of the corrections, without using extraordinary means, the system is ready to acquire the grades and to end anonymity automatically.

In the course of a step 1783, the author sections are read to associate an identification of the candidate with each first code and this association is memorized.

Then, to the extent the correctors complete their corrective sections or their overall grading forms, these latter are read, the grades attributed and the results immediately available after the final reading, and the anonymity can be automatically ended under the monitoring of a unique person responsible having the anonymity-ending file, step 1785, by means of the first and second codes, and matching the identification of the candidate with each grade given him.

This system permits instantaneously having a pre-planned jury report, if there is a preliminary definition of the coefficient of each grade and attribution of the different tests to a jury. The statistical results are immediately available so as to permit the jury to define its eventual pass rate. Moreover, the assembly of the grades per collector being adapted to be compared between correctors, the possibilities of adjustment between correctors can be decided according to the criteria of the jury. Without requiring any supplemental operation, the proposed system renders completely anonymous a test with a rapidity and a reliability of execution that is total and without precedent.

This permits the assembly of the agents, particularly the instructors, to devote themselves entirely to their pedagogical and evaluative tasks, by freeing them from burdensome administrative operations.

In the case of unmasked second codes B, these latter must remain unknown to the candidates so that they cannot communicate it to the correctors or the correctors cannot easily recognize this code. A contrary need arises from the fact that the management of the administrative sections must be able to be ensured easily by being able to refer to a legible and editable code. The use of a barcode easily decryptable by a portable reading wand is possible but has because of this fact problems of security that arise and are resolved by others. To avoid any possibility of decryption, two variants of coding system, alphanumerical or graphical, are proposed.

FIG. 10 shows the principle of the alphanumerical grid codes 1000. The first code A is associated with a second masked or encrypted code B. This encrypted code B is thus identical to the masked B but is not directly visually readable. To permit direct reading and by scanner, the format of the code is given in alphanumeric symbols, digits and the usual letters, but these symbols are “embedded” in an assembly of other alphanumeric symbols, as shown in FIG. 10. The code is integrated into a grid of alphanumeric symbols 1000 (a unique digit or a unique letter per case), all the elements which do not belong to the second code B being subject to random variation. The elements of the code have a fixed place 1010 in the grid, so as to permit:
a direct easy reading of the second code by means of a specific mask 1020 having indexed holes for each element of the code, this mask is specific to an assembly of anonymity forms and is confided to a responsible person.
a reading by scanner of the unique boxes of the grid corresponding to the second code.

In the case of reading by scanner, at least one of the alphanumeric values which does not belong to the second code can form a part of a monitoring code of the value of the second code B that is read. In the case of graphic grid codes 1100 that are encrypted, shown in FIG. 11, the second encrypted code B is always identical to the code B but the code is not present in the form of the usual digits and letters, but on the contrary, is in the form of graphical signs embedded in an assembly of other graphical signs, a unique type or several types being adapted to be used conjointly, a unique being “valid”. The second code B is integrated into a grid of graphical signs 1100 having, moreover at the most, a unique graphical sign per case, that can vary randomly for each case except for the values of the zones reserved for the representation of the second code B. The values representing the second code B are located in predetermined zones 1110 of the grid so as to permit:
an easy direct reading of the second code by means of a specific mask 1120 having indexed holes for each element of the code, this mask is specific to assembly of anonymity forms and is confided to a responsible person.
a reading by scanner of the unique zones of the grid corresponding to the code. In the case of reading by scanner, the graphical zones contained in at least one of the distraction zones (which is to say not belonging to the code) can represent a monitoring code of the value of the second code B.

We have set forth the principles of use of two codes to manage an assembly of complex and different cases of anonymity. As we have seen, the independence of these two codes permits management without fault of the anonymity data so that the participants—candidates or certain other involved persons, cannot know the code B of one or several forms by associating it to the code A. In the absence of masking of the code B, the use of a code B in the form of an encrypted code is a solution which creates, for conventional barcodes, a problem of relative reliability because it is possible to read these codes, after running their coding, or with a portable reading wand for the more complex codes (interlaced). This is why it may be useful to use a series of supplemental codes to render more complex any “pirate” ending of anonymity.

This method can be used in the management of unmasked second codes B in the form of barcodes with the use or not of lists of results. In this method, the second unmasked code B, having the form of a barcode (or any other type) on the form, is read, recorded in a file and associated in this file with a simple alphanumeric code, then on the administration section of the anonymity form, the code or codes are replaced by one or several labels on which a simple alphanumeric code, identical for each form, is printed. The label system can be replaced by printing of masking of the second code B on the form with printing to the side of the simple alphanumeric code associated by computer.

These operations can be carried out automatically by an automatic indexing system of the copies or forms described above with regard to FIGS. 12 to 15. As we have seen in the preceding developments, it may be useful to have a simple coding system to manage the anonymous data: copies of the result or results associated with them. Moreover, the second codes B may be indecipherable before separation of the author section, to ensure perfect anonymity. The association of a third simple alphanumeric supplemental code C, with each encrypted second code B, is an elegant solution but which can take up more time and thus be costly. The present invention provides a machine permitting attributing a supplemental code or a simple alphanumeric index, to anonymity forms associated with documents or physical elements.

FIGS. 12 and 13 show a machine for automatic indexing or re-indexing. This type of machine is adapted to read a code on a document or a physical element. The machine 1200 is comprised:
by a reading module 1201, composed by an infrared reading head for standard barcodes or a reading module or CCD camera for any other type of reading interpreted by computer and by motors for reading handwritten entries, printing, standard barcodes or for reading by scanner encrypted codes in boxes to be checked and graphical scales,
by a direct printing module or pneumatic label application 1303 with a module 1202 for printing labels,
by a monitoring module 1205, comprised by a reading head or CCD camera for reading interpreted by computer and by motors for reading printed entries, of barcodes with explicit reading (with indication of their value according to ASCII characters), and
by a compartmented traveling tape 1306 with the format of copies 1305 which drives these.

The reading module 1201 carries out the reading of the second code B. The reading of the code triggers a computer management by computer connection 1203 with a computer 1204, which defines an association with an explicit ordered code (of the first copy of the latter and in order), this explicit code is immediately printed, directly or on a label secured to a precise position on the copy.

The monitoring module 1205 comprised by a reading head or CCD camera for interpreted reading by computer and by motors for printed reading of writing, of barcodes with explicit reading (with the indication of their value in ASCII characters) permits monitoring the good printing of the explicit code and its conformity with the predefined series. The indexed or re-indexed copies are then placed by ordered lots in a receptacle 1206.

The explicit code can be printed on the form after printing of the masking of the first code or on an inseparable secured label so as to prevent recognition of the first code. In this case, as a modification, a first code A is repeated on the administrative section, the association with a supplemental code which identifies it to the second code B, the association being carried out during re-indexing, by the machine of FIG. 12 to 14.

In a machine 1400 to index or re-index semi-automatically, shown in FIGS. 14 and 15, the copy 1403 is introduced manually and a corrector 1404 triggers a reading module 1401, comprised by an infrared reading head of standard barcodes or by a reading module or CCD camera, for all types of computer interpreted reading and by motors for reading printed writing, of standard barcodes or with scanner reading, of encrypted codes shown in FIGS. 10 and 11, of check boxes and of graphical scales. A computer management by a computer connection with a computer defines an association between the code that is read and an ordered explicit code. Under the influence of pressure, the copy 1403 encounters, at the end of its path, two detectors 1405, placed in series so as to ensure perfect positioning of the copies. These detectors 1405 trigger the printing of an explicit complementary code, directly or on a grid label, by a printing module 1402 and a positioning of the complementary code explicit to a precise position on the copy 1403. In this version, monitoring is carried out visually.

1. Process for anonymous and computerized processing of a document or a physical element, hereinafter called “physical element”, whose author or proprietor, hereafter called “author”, must remain unknown during processing of the physical element (1775), this processing being characterized in that it comprises:
a step (1716) of association or integration with the physical element of a unique information support (300, 900), comprising:
an identification section for the author called author section bearing a first predetermined code,
at least one so-called “administrative” section each bearing a second predetermined code identical to or different from the first predetermined code,
these sections forming a unique couple, the codes being previously defined in the step of association or integration,
a step of permanent association of an identification of the author with the author section (1717);
a step of separation of the author section from the physical element (1740), each administrative section remaining attached to or integral with the physical element;
a step of processing the material element separated from the author section (1775), to provide at least one result of processing the physical element;
a step of reading the author section (1783) to read and associate the first code with the identification of the author of the physical element;
a step of reading at least one administration section (1784), to read and associate the second code with at least a result of processing of the physical element;
a step of placing in correspondence by means of codes, at least one result of processing with the identification of the author of the physical element, permitting ending anonymity (1785);
at least one of the reading steps comprising a phase of optoelectronic reading and recognition.

2. Process according to claim 1, characterized in that the first code is unique and different from each second also unique code.

3. Process according to claim 2, characterized in that the relationship between the first code and each second code is generated by an unpredictable computer algorithm which is a random variable and in that the value of said variable and/or a table of correspondence of codes is memorized.

4. Process according to claim 2, characterized in that the relationship between the first code and each second code is generated by an unpredictable computer algorithm which uses a variable representative of a type of content of the physical element and in that the value of said variable and/or a table of correspondence of the codes is memorized.

5. Process according to claim 1, characterized in that at least one administration section constitutes the physical element.

6. Process according to claim 1, characterized in that, in the course of the processing step, the information carried by the author on the administration section is processed and there is furnished at least one result in the form of at least one value or grade.

7. Process according to claim 1, characterized in that the unique information support comprises an identification stub comprising one of the codes, said stub remaining connected to the physical element of durable material.

8. Process according to claim 1, characterized in that it comprises a step of inscription of at least one result of the processing step on at least one administration section and one step of separation of at least one administration section from the physical element, before the step of reading said administrative section.

9. Process according to claim 1, characterized in that it comprises a step of reading the identification of the author conjointly with the step of reading the author section and memorizing the correspondence between the first code and the identification of the author.

10. Process according to claim 1, characterized in that it comprises a step of masking at least one of the codes at least until the step of separation of the author section.

11. Process according to claim 1, characterized in that it comprises a step of masking by a unique masking element of at least one code at least until the step of separation of the author section.

12. Process according to claim 1, characterized in that it comprises a step of reading (1784) at least one result of processing conjointly with the step of reading each administration section.

13. Process according to claim 1, characterized in that the unique information support comprises several administration sections bearing the same unique second code and a supplemental code defining the number of the section.

14. Process according to claim 1, characterized in that in the course of the step of permanent association of an identification of the author to the author section, the identification of the participant is carried out by handwriting or by a modifiable code in a handwritten manner or in the form of a group of boxes to be checked with alphanumeric value.

15. Process according to claim 1, characterized in that at least one of the codes is integrated into a grid of alphanumeric values comprising at least one alphanumeric symbol per box, the elements of the code having a predetermined place in the grid.

16. Process according to claim 1, characterized in that at least one of the codes corresponds to graphical symbols integrated into a grid of graphical symbols whose elements corresponding to the code have a predetermined place in the grid.

17. Process according to claim 15, characterized in that at least one of the boxes which does not correspond to the code comprises a supplemental code for monitoring the value of the code in the form of alphanumeric values or graphic signs, in that each box which comprises the supplemental code is read and in that the code is monitored as a function of the content of said boxes.

18. Process according to claim 1, characterized in that it comprises an intermediate and supplemental changing of the codes comprising:
a step of reading by optoelectronic process of an identification and/or of an unmasked code associated with the identified physical element;
a step of recording the identification or the code in a computer file;
a step of placing in correspondence this identification and/or this code with an explicit and sequential index code adapted to be read and interpreted visually;
a step of printing of this index code in the course of which the identification and/or the previously read code on the physical element is masked, by gluing a label for example; the physical elements being thus indexed in an anonymous manner, the identification and/or the code read and masked and the corresponding index code being associated in a memorized file.

19. Process according to claim 1, characterized in that at least one of the second codes is not masked during a step of distribution to the authors of the unique information supports associated with the physical elements, and is in the form of encrypted codes readable by scanner or by a barcode reading wand.

20. Process according to claim 1, characterized in that at least one result of the step of processing is reported on at least one list comprising a series of codes representative of second codes, the step of placing in correspondence being then carried out by optoelectronic reading of said list or by manual acquisition of the results in a computer file comprising said list.

21. Process according to claim 1, characterized in that each second code is not masked and is in the form of encrypted codes, or of graphic grill codes with optoelectronic reading.

22. Process according to claim 1, characterized in that each second code is masked during a step of distribution to the authors of the unique information supports associated with the physical elements, and is identical to the first code, the first code being in the form of encrypted code, or in the form of code corresponding to graphic signs integrated into a grid of graphic signs whose elements corresponding to the code have a predetermined place in the grid, or in the form of a code integrated into the grid of alphanumeric values comprising at least one alphanumeric symbol per box, the elements of the code having a predetermined place in the grid.

23. Machine to re-index the elements identified by codes, using the process according to claim 1, characterized in that it comprises:
a reading device by optoelectronic process of a written identification or of a code, carried by the physical element or on the unique information support;
a computer device for recordation of the written identification or of the code read in a digital file and which associates in said digital file an explicit and sequential index code adapted to be read and interpreted visually;
a device for printing this index code;
a system for masking the written identification or the code read on each physical element,
such that each physical element is thus re-indexed in an anonymous manner and is adapted to be visually interpreted.

24. Form for anonymous processing of a physical element, characterized in that it comprises:
an author section associated with a first code and adapted to receive an identification of the author of the physical element;
at least one second administrative section associated with a second code identical to or different from the first code;
these sections being connected to form a unique couple, the codes being either identical and specific for each form, or different and corresponding for each form in an unpredictable manner, the form being adapted to be secured to the physical element, the author section being provided to be detached from the administrative section, the administration section remaining associated with the physical element.

25. Form according to claim 24, characterized in that it comprises moreover a stub carrying first and/or second codes, said stub being associated permanently with the physical element.

26. Form according to claim 24, characterized in that it comprises at least one administrative section associated with the second code and/or with a complementary code representative of the second code, the complementary code being adapted to be different for each administrative section.

27. Form according to claim 24, characterized in that it comprises a mask adapted to mask at least one code.

28. Form according to claim 24, characterized in that at least one administrative section is adapted to receive at least one result of processing of the physical element, in the form of at least one value or grade.

29. Form according to claim 24, characterized in that at least one administrative section is adapted to be directly filled in by the author: for example, a questionnaire, a multiple choice questionnaire.

30. Label for masking code used in the process according to claim 1, characterized in that it is opaque and comprises a pre-cutout of an internal zone which during separation of the sections is detached and leaves visible at least one code previously imprinted on at least one of the sections.
